(19) United States
(12) Patent Application Publication
(10) Pub. No.: US 2026/0316010 A1
(43) Pub. Date: Oct. 15, 2026

(54) CARTRIDGE UNIT FOR FLOW ELECTRODE AND FLOW ELECTRODE CAPACITIVE DEIONIZATION APPARATUS USING SAME

(71) Applicant: Electrowater Co. Ltd., Busan (KR)

(72) Inventor: Hyun Chul HUR, Seoul (KR)

(21) Appl. No.: 19/484,478

(22) PCT Filed: Sep. 25, 2023
(86) PCT No.: PCT/KR2023/014613

§ 371 Date: Nov. 14, 2025

(30) Foreign Application Priority Data
Jun. 8, 2023 (KR) 10-2023-0073403
Sep. 25, 2023 (KR) 10-2023- 0127654

(51) Int. Cl. B01D 61/46; C02F 1/469

(52) U.S. Cl. CPC B01D 61/464; C02F 1/4691; B01D 2311/2623; B01D 2313/345; B01D 2313/44; B01D 2325/42; C02F 2201/46

(57) ABSTRACT

The present invention relates to a cartridge unit for a flow electrode, and a flow electrode capacitive deionization apparatus using same. The cartridge unit for a flow electrode, according to an embodiment of the present invention, comprises: a first case, which has a first ion-passing hole formed in a plate surface thereof; a second case which has a second ion-passing hole formed in a plate surface thereof, and which is coupled to the first case such that a flow electrode channel on which an electrode fluid flows is formed therein; a first ion-permeable membrane attached to the plate surface of the first case so as to block the first ion-passing hole; a second ion-permeable membrane attached to the plate surface of the second case so as to block the second ion-passing hole; and an electrode plate disposed inside the flow electrode channel, and, when power is applied to the electrode plate, ions having passed through the first ion-permeable membrane and the second ion-permeable membrane move along the flow electrode channel.

### TECHNICAL FIELD

The present disclosure relates to a cartridge unit for a flow electrode and a flow electrode capacitive deionization apparatus using the same. More particularly, the present disclosure relates to a cartridge unit for a flow electrode and a flow electrode capacitive deionization apparatus using the same, both used in water treatment in flow electrode capacitive deionization.

### BACKGROUND ART

Recently, countries around the world have been focusing their efforts on developing clean alternative energy sources to solve air pollution and global warming issues. Specifically, ocean energy generation utilizing the concentration difference of electrolytes has recently emerged as a major new are of focus.

Furthermore, the development of large-capacitive power storage technologies capable of storing electrical energy generated through various alternative energy sources has emerged as a core element of the future green industrial base. Most of these future power storage technologies are methods such as Li-ion batteries or super-capacitors that utilize the principle of ion adsorption (charging) and desorption (discharging), and countries around the world have made efforts in development and research intended to achieve high-efficiency compactness and large capacity by improving the charge-discharge characteristics of materials and components.

Meanwhile, in the field of water treatment, such as purification or wastewater treatment, and seawater desalination, in case of water pollution and water shortage, a process capable of water treatment using the same principle as described above at significantly lower energy cost compared to conventional evaporation or reverse osmosis (RO) methods, that is, the capacitive deionization (CDI) process is currently under development.

The primary issues in power storage and water treatment systems using the same principle as described above are efficiency degradation and high equipment costs during large capacity implementation. Specifically, the large area implementation of electrodes for scaling up, the resulting non-uniform electric field distribution within the electrodes, the limited amount of active material of thin film electrodes coated onto current collectors, the reduced contact area between active material and electrolyte due to binders during the coating process, and the decrease in charge-discharge efficiency require the stacking of multiple unit cells. Therefore, the high cost of the equipment, particularly in the case of the capacitive deionization (CDI) process, increased operating cost caused by pressure loss in the water (electrolyte) flow within the stack has been pointed out as a problem.

Recently, a new GDI approach, flow electrode capacitive deionization (FCDI), has been proposed. For example, Korean Patents No. 10-1233295 and No. 10-1318331 are examples thereof.

Flow electrode capacitive deionization technology requires a design, such as increasing electrode surface area, to achieve large capacity. There is a demand for the development of flow electrode capacitive deionization technology that can increase electrode capacity while reducing installation space, maximize the contact area between flow electrodes and inlet water, and enable structural simplification.

### DISCLOSURE

### Technical Problem

Accordingly, the present disclosure has been made keeping in mind the above problems occurring in the related art, and an objective of the present disclosure is to provide a flow electrode capacitive deionization apparatus, which is capable of increasing electrode capacity while reducing installation space, maximizing the contact area between a flow electrode and raw water, and enabling structural simplification.

Another objective of the present disclosure is to provide a cartridge unit for a flow electrode and a flow electrode capacitive deionization apparatus using the same, the cartridge unit being capable of facilitating replacement and management of a positive or negative unit and adjustment of the size thereof.

### Technical Solution

In order to achieve the objective, according to the present disclosure, there is provided a cartridge unit for a flow electrode, the cartridge unit including: a first case with a plate surface on which first ion-passing holes may be formed, a second case with a plate surface on which second ion-passing holes may be formed, and coupled to the first case to form a flow electrode channel to allow an electrode fluid to flow therein, a first ion-permeable membrane attached to the plate surface of the first case and blocking the first ion-passing holes, a second ion-permeable membrane attached to the plate surface of the second case and blocking the second ion-passing holes, and an electrode plate located in the flow electrode channel; and when power is exerted to the electrode plate, ions passing through the first ion-permeable membrane and the second ion-permeable membrane may be moved along the flow electrode channel.

At this point, the cartridge unit may further include: a pair of electrode fluid inlet tubes spaced apart from each other in a lateral direction on an upper portion of the plate surface of each of the first case and the second case, and formed through each of the first case and the second case in a front-rear direction, and a pair of electrode fluid outlet tubes spaced apart from each other in a lateral direction on a lower portion of the plate surface of each of the first case and the second case, and formed through the first case and the second case in a front-rear direction; wherein an electrode fluid inlet hole may be formed on one of the pair of electrode fluid inlet tubes to allow the corresponding electrode fluid inlet tube and the flow electrode channel to communicate with each other, so that the electrode fluid flowing through the electrode fluid inlet tube may flow toward the flow electrode channel through the electrode fluid inlet hole; and an electrode fluid outlet hole may be formed on one of the pair of electrode fluid outlet tubes to allow the corresponding electrode fluid outlet tube and the flow electrode channel to communicate with each other, so that the electrode fluid in the flow electrode channel may be discharged to the electrode fluid outlet tube through the electrode fluid outlet hole.

Furthermore, the electrode fluid inlet tubes may include first case inlet tubes protruding from the first case toward the second case, and second case inlet tubes protruding from the second case toward the first case, and the electrode fluid outlet tubes may include first case outlet tubes protruding from the first case toward the second case, and second case outlet tubes protruding from the second case toward the first case; wherein when the first case and the second case are coupled to each other, the first case inlet tubes and the second case inlet tubes may be connected to each other to form the electrode fluid inlet tubes, and the first case outlet tubes and the second case outlet tubes may be connected to each other to form the electrode fluid outlet tubes.

Furthermore, when the first ion-permeable membrane and the second ion-permeable membrane are positive ion-exchanging films, the electrode fluid inlet hole may be formed in one of the pair of electrode fluid inlet tubes; and when the first ion-permeable membrane and the second ion-permeable membrane are negative ion-exchanging films, the electrode fluid inlet hole may be formed in the other of the pair of electrode fluid inlet tubes.

Furthermore, the electrode fluid inlet hole and the electrode fluid outlet hole may be formed at the electrode fluid inlet tube and the electrode fluid outlet tube that are respectively located in a diagonal direction.

Furthermore, the plurality of first ion-passing holes and the plurality of second ion-passing holes may be formed on the plate surface of the first case and the plate surface of the second case.

Furthermore, the first ion-permeable membrane may be attached on a front surface of the first case at the outside space of the flow electrode channel; and the second ion-permeable membrane may be attached on a rear surface of the second case at the outside space of the flow electrode channel.

Furthermore, at least one of the first and second cases may include a plurality of inverted V-shaped dispersive guide ribs that protrude from an inner plate surface toward the electrode plate; and the electrode fluid flowing inward through the electrode fluid inlet hole may be guided by each of the dispersive guide ribs and flow downward while being dispersed in the lateral direction inside the flow electrode channel.

Furthermore, at least one of the first and second cases may include a discharge guide rib that may protrude from a lower area of an inner plate surface toward the electrode plate, and be formed to be inclined downward toward the electrode fluid outlet hole; and the electrode fluid flowing downward in the flow electrode channel may be guided by the discharge guide rib and enabled to flow in a direction toward the electrode fluid outlet hole.

Meanwhile, in order to achieve the above objective, according to another embodiment of the present disclosure, there is provided a flow electrode capacitive deionization apparatus, which includes: a cartridge array module in which a plurality of cartridge units for a flow electrode may be arranged to face each other in a first direction while being spaced apart from each other, an external inlet tube supplying the electrode fluid to the cartridge array module, an external outlet tube discharging the electrode fluid passing through the cartridge array module, and a positive power line and a negative power line alternately connected to each electrode plate of the plurality of cartridge units for a flow electrode, so that the plurality of cartridge units for a flow electrode may be provided with a positive cartridge unit for a flow electrode and a negative cartridge unit for a flow electrode alternately arranged in the first direction.

At this point, each of the cartridge units for a flow electrode may further include: a pair of electrode fluid inlet tubes spaced apart from each other in a lateral direction on an upper portion of the plate surface of each £ of the first case and the second case, and formed through each of the first case and the second case in a front-rear direction, and a pair of electrode fluid outlet tubes spaced apart from each other in a lateral direction on a lower portion of the plate surface of each of the first case and the second case, and formed through the first case and the second case in a front-rear direction; wherein the electrode fluid inlet tubes at corresponding positions of the pair of electrode fluid inlet tubes of the cartridge units for a flow electrode may be connected to each other in the first direction to form a first inner inlet tube and a second inner inlet tube; the electrode fluid outlet tubes at corresponding positions of the pair of electrode fluid outlet tubes of the cartridge units for a flow electrode may be connected to each other in the first direction to form a first inner outlet tube and a second inner outlet tube; an electrode fluid inlet hole may be formed in the electrode fluid inlet tube, which may provide the first inner inlet tube, of the pair of electrode fluid inlet tubes of the positive cartridge unit for a flow electrode, and an electrode fluid inlet hole may be formed in the electrode fluid inlet tube, which may provide the second inner inlet tube, of the pair of electrode fluid inlet tubes of the negative cartridge unit for a flow electrode; and an electrode fluid outlet hole may be formed in the electrode fluid outlet tube, which may provide the first inner outlet tube, of the pair of electrode fluid outlet tubes of the negative cartridge unit for a flow electrode, and an electrode fluid outlet hole may be formed in the electrode fluid outlet tube, which may provide the second inner outlet tube, of the pair of electrode fluid outlet tubes of the positive cartridge unit for a flow electrode.

Furthermore, the first ion-permeable membrane and the second ion-permeable membrane of the positive cartridge unit for a flow electrode may be negative ion-exchanging films, and the first ion-permeable membrane and the second ion-permeable membrane of the negative cartridge unit for a flow electrode may be positive ion-exchanging films.

Furthermore, the external inlet tube may be connected to the pair of electrode fluid inlet tubes of the foremost cartridge unit for a flow electrode of the plurality of cartridge units for a flow electrode, and supply the electrode fluid to the first inner inlet tube and the second inner inlet tube; and the external outlet tube may be connected to the pair of electrode fluid outlet tubes of the rearmost cartridge unit for a flow electrode of the plurality of cartridge units for a flow electrode, and discharge the electrode fluid that may flow through the first inner outlet tube and the second inner outlet tube.

Furthermore, the rear portions of the pair of electrode fluid inlet tubes of the rearmost cartridge unit for a flow electrode of the plurality of cartridge units for a flow electrode may be blocked; and the front portions of the pair of electrode fluid outlet tubes of the foremost cartridge unit for a flow electrode of the plurality of cartridge units for a flow electrode may be blocked.

Furthermore, the pair of electrode fluid inlet tubes and the pair of electrode fluid outlet tubes of each cartridge unit for a flow electrode may protrude respectively forward and rearward from the first case and the second case; and the pair of electrode fluid inlet tubes and the pair of electrode fluid outlet tubes of the rear cartridge unit for a flow electrode and the pair of electrode fluid inlet tubes and the pair of electrode fluid outlet tubes of the front cartridge unit for a flow electrode may be inserted such that one is inserted into the other, thereby forming the first inner inlet tube, the second inner inlet tube, the first inner outlet tube, and the second inner outlet tube.

Furthermore, a side surface of the first case of each cartridge unit for a flow electrode may include a pair of hook members that may protrude in a vertical direction forward, and the second case may include hook grooves formed at positions corresponding to the hook members, and when the pair of electrode fluid inlet tubes and the pair of electrode fluid outlet tubes of the rear cartridge unit for a flow electrode are coupled to the pair of electrode fluid inlet tubes and the pair of electrode fluid outlet tubes of the front cartridge unit for a flow electrode, the hook members may be inserted into the hook grooves, so that the rear cartridge unit for a flow electrode and the front cartridge unit for a flow electrode may be coupled to each other while being spaced apart from each other.

### Advantageous Effects

According to the present disclosure, the cartridge array module is submerged in the reservoir where raw water requiring ion removal flows, and a water treatment process is performed to increase treatment capacity.

Furthermore, the positive cartridge unit for a flow electrode and the negative cartridge unit for a flow electrode of the cartridge array module are formed into a cartridge-type module to maximize the contact area with respect to the raw water, thereby increasing the process performance.

Furthermore, the cartridge unit is formed into a large-area cartridge to support large-area implementation, and reduce the installation space.

Furthermore, the positive cartridge unit for a flow electrode and the negative cartridge unit for a flow electrode are modularized to facilitate management of each unit, thereby providing suitable effects for assembly, installation, and maintenance.

### DESCRIPTION OF DRAWINGS

FIG. 1 is a view illustrating an example of configuration of a flow electrode capacitive deionization apparatus according to an embodiment of the present disclosure,

FIG. 2 is a front perspective view illustrating a cartridge array module according to the embodiment of the present disclosure,

FIG. 3 is a rear perspective view illustrating the cartridge array module according to the embodiment of the present disclosure,

FIG. 4 is a partially exploded-perspective view illustrating the cartridge array module according to the embodiment of the present disclosure,

FIG. 5 is a sectional view taken along line A-A of FIG. 4,

FIG. 6 is a sectional view taken along line B-B of FIG. 4,

FIG. 7 is an exploded-perspective view illustrating the cartridge unit for a flow electrode according to the embodiment of the present disclosure, and

FIG. 8 is a perspective view illustrating a first case and a second case of the cartridge unit for a flow electrode according to the embodiment of the present disclosure.

### BEST MODE

The present disclosure relates to a cartridge unit for a flow electrode, a first case with a plate surface on which first ion-passing holes are formed, a second case with a plate surface on which second ion-passing holes are formed on, and coupled to the first case to form a flow electrode channel for an electrode fluid to flow therein, a first ion-permeable membrane attached to the plate surface of the first case and blocking the first ion-passing holes, a second ion-permeable membrane attached to the plate surface of the second case and blocking the second ion-passing holes, and an electrode plate provided in the flow electrode channel; wherein when power is exerted on the electrode plate, ions passing through the first ion-permeable membrane and the second ion-permeable membrane are moved along the flow electrode channel.

### Mode for Invention

The above and other objects, features and advantages of embodiments of the present disclosure, and a method of achieving them will be more clearly understood with reference to the embodiments described below in detail in conjunction with the accompanying drawings. However, the present disclosure is not limited to the following embodiments, and can be embodied in various forms different from each other, and embodiments of the present disclosure are presented to make complete disclosure of the present disclosure and help those who are ordinarily skilled in the art to which the present disclosure belongs understand the present disclosure. The present disclosure is only defined by the scope of the claims. The same reference numerals used throughout the present specification may indicate the same or similar elements.

Hereinbelow, exemplary embodiments of the present disclosure will be described with reference to accompanying drawings.

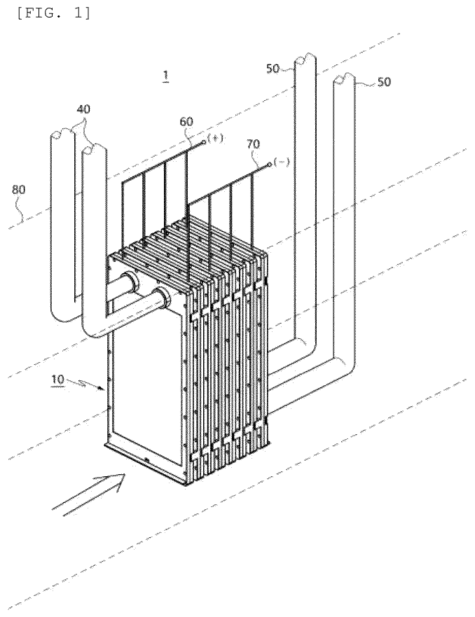

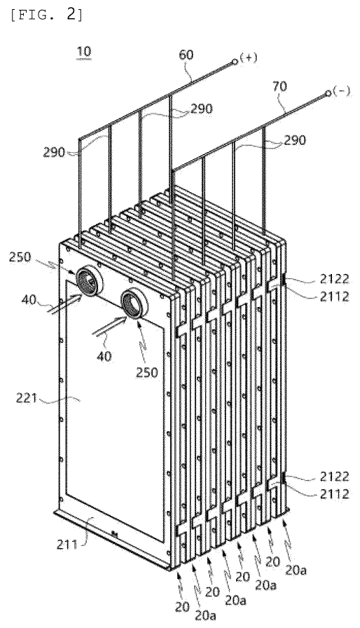

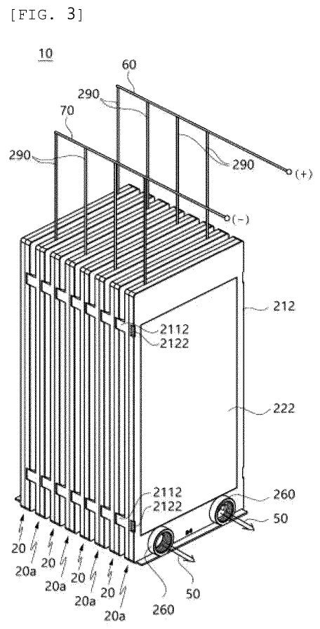

FIG. 1 is a view illustrating an example of configuration of a flow electrode capacitive deionization apparatus 1 according to an embodiment of the present disclosure. FIG. 2 is a front perspective view illustrating a cartridge array module 10 according to the embodiment of the present disclosure. FIG. 3 is a rear perspective view illustrating the cartridge array module 10 according to the embodiment of the present disclosure.

Referring to FIGS. 1 to 3, according to the embodiment of the present disclosure, the flow electrode capacitive deionization apparatus 1 may include the cartridge array module 10, an external inlet tube 40, an external outlet tube 50, a positive power line 60, and a negative power line 70.

In the embodiment of the present disclosure, FIG. 1 illustrates an example of the submerged-type flow electrode capacitive deionization apparatus 1. As shown in FIG. 1, the cartridge array module 10 processes raw water in a capacitive deionization (CDI) process while submerged in a reservoir 80, where the raw water to be deionized flows.

According to the embodiment of the present disclosure, the cartridge array module 10 includes a plurality of cartridge units 20, 20a for a flow electrode, the cartridge units being arranged at intervals to face each other in the first direction.

The external inlet tube 40 is connected to the cartridge array module 10, and supplies an electrode fluid to each cartridge unit 20, 20a for a flow electrode. Furthermore, the external outlet tube 50 discharges the electrode fluid, which passes through the cartridge unit 20, 20a for a flow electrode constituting the cartridge array module 10, outward of the cartridge array module 10.

The positive power line 60 and the negative power line 70 are alternately connected to electrode plates 240, which will be described below, of the plurality of cartridge units 20, 20a for a flow electrode so that the plurality of cartridge units 20, 20a for a flow electrode is arranged with a positive cartridge unit 20 for a flow electrode and a negative cartridge unit 20a for a flow electrode that are alternately arranged in a first direction, and the description thereof will be described below.

According to the configuration, the raw water flowing through the reservoir 80 flows between the positive cartridge unit 20 for a flow electrode and the negative cartridge unit 20a for a flow electrode, and positive ions in the raw water are moved to the negative cartridge unit 20a for a flow electrode, and negative ions are moved to the positive cartridge unit 20 for a flow electrode, thereby allowing deionization of the raw water.

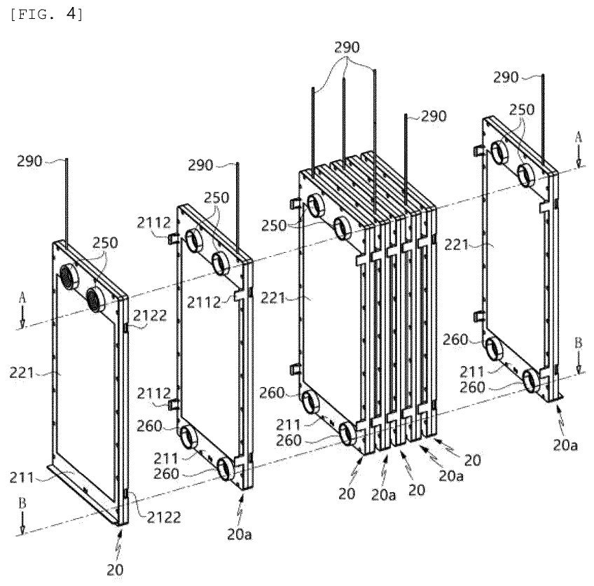

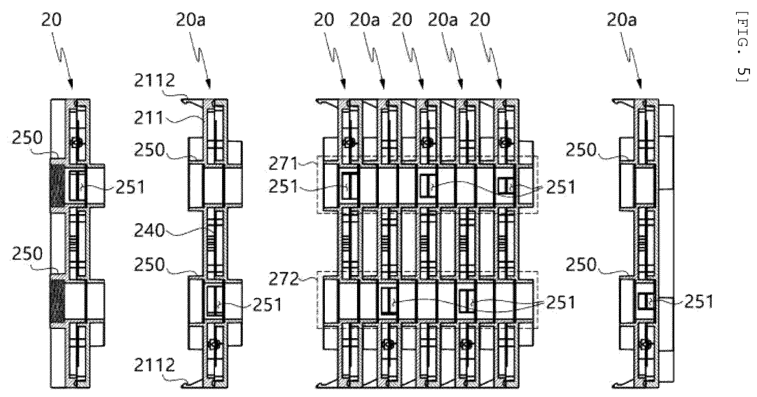

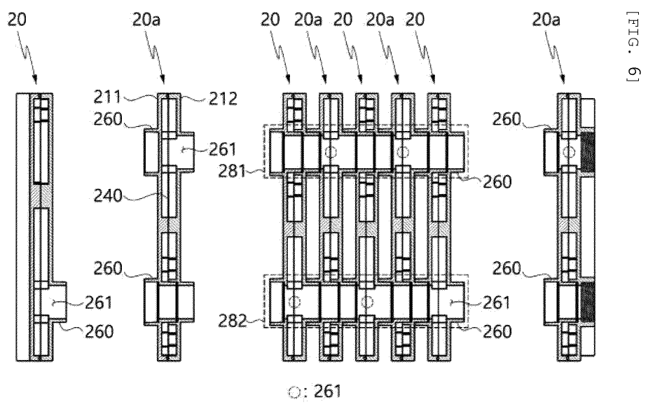

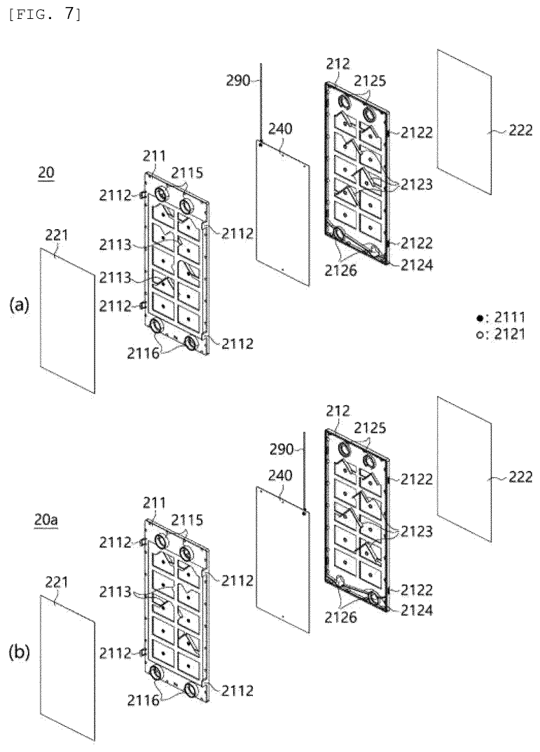

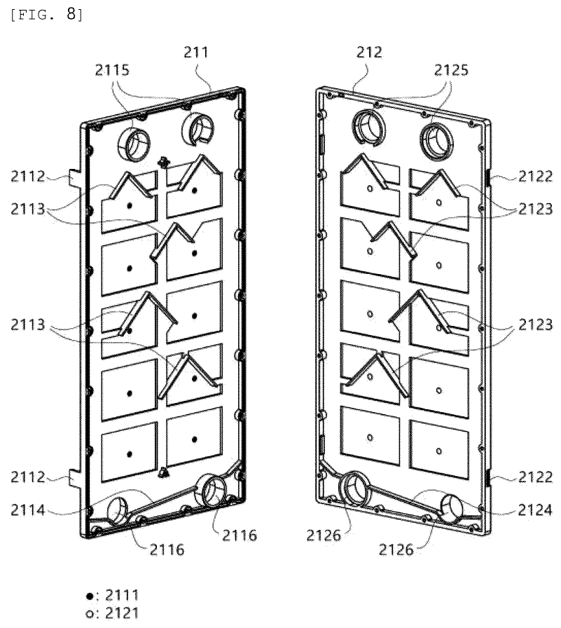

FIG. 4 is a partially exploded-perspective view illustrating the cartridge array module 10 according to the embodiment of the present disclosure. FIG. 5 is a sectional view taken along line A-A of FIG. 4. FIG. 6 is a sectional view taken along line B-B of FIG. 4. FIG. 7 is an exploded-perspective view illustrating the cartridge unit 20, 20a for a flow electrode according to the embodiment of the present disclosure. FIG. 8 is a perspective view illustrating a first case 211 and a second case 212 of the cartridge unit 20, 20a for a flow electrode according to the embodiment of the present disclosure.

Hereinbelow, referring to FIGS. 2 to 8, the cartridge array module 10 and the cartridge unit 20, 20a for a flow electrode included therein, according to the embodiment of the present disclosure, will be described in detail.

According to the embodiment of the present disclosure, the cartridge unit 20, 20a for a flow electrode may include the first case 211, the second case 212, a first ion-permeable membrane 221, a second ion-permeable membrane 222, and an electrode plate 240.

The first case 211 and the second case 212 are connected to each other forward and rearward, and form a flow electrode channel 230 therebetween. At this point, the electrode fluid flows in the flow electrode channel 230, and when power is exerted to the electrode plate 240, the electrode fluid generates a flow electrode.

As an embodiment, a super capacitor slurry, such as activated carbon, is distributed in the electrode fluid, and generates a flow electrode when power is exerted through the electrode plate 240, thereby collecting ions in the raw water flowing outside the cartridge unit 20, 20a for a flow electrode by electrical properties. At this point, ions moved into the cartridge unit 20, 20a for a flow electrode are adsorbed by the super capacitor slurry and flow with the electrode fluid.

Meanwhile, first ion-passing holes 2111 may be formed on a plate surface of the first case 211. According to the embodiment of the present disclosure, the plurality of first ion-passing holes 2111 is formed on the plate surface of the first case 211, as an example. According to the embodiment, as an example, the first case 211 may have a rectangular plate surface, and the plurality of first ion-passing holes 2111 may be formed to be distributed in an external wall window, as an example.

Second ion-passing holes 2121 may be formed on the plate surface of the second case 212. To correspond to the first case 211, the plurality of second ion-passing holes 2121 may be formed on the plate surface of the second case 212. As an embodiment, the plate surface of the second case 212 may include a rectangular plate surface to correspond to the shape of the first case 211, and the plurality of second ion-passing holes 2121 may be formed to be distributed in an external wall window, as an example.

According to the embodiment of the present disclosure, the first ion-permeable membrane 221 is attached to the plate surface of the first case 211 and blocks the first ion-passing holes 2111. Furthermore, the second ion-permeable membrane 222 is attached to the plate surface of the first case 211 and blocks the second ion-passing holes 2121.

As an embodiment, the first ion-permeable membrane 221 may be attached to the first case 211 at a front space of the first case 211, i.e., an external space of the flow electrode channel 230, as an example. Furthermore, the second ion-permeable membrane 222 may be attached to the second case 212 at a rear space of the second case 212, i.e., an external space of the flow electrode channel 230.

According to the embodiment of the present disclosure, the electrode plate 240 is located in the flow electrode channel 230. At this point, an electrode extracting line 290 may be electrically connected to an upper portion of the electrode plate 240, and extend outward to be electrically connected to the positive power line 60 or the negative power line 70.

When power is exerted to the electrode plate 240 according to the above configuration, ions passing through the first ion-permeable membrane 221 and the second ion-permeable membrane 222 are moved into the first case 211 and the second case 212 through the first ion-passing holes 2111 and the second ion-passing holes 2121, and adsorbed on the super capacitor slurry in the electrode fluid, so that the raw water can be deionized.

More specifically, as described above, the positive cartridge unit 20 for a flow electrode and the negative cartridge unit 20a for a flow electrode are arranged alternately at intervals to form the cartridge array module 10.

At this point, the electrode extracting line 290 of the positive cartridge unit 20 for a flow electrode is connected to the positive power line 60, and the electrode extracting line 290 of the negative cartridge unit 20a for a flow electrode is connected to the negative power line 70.

At this point, the first ion-permeable membrane 221 and the second ion-permeable membrane 222 of the positive cartridge unit 20 for a flow electrode may be negative ion-exchange films. Therefore, when positive power is exerted through the positive power line 60 of the positive cartridge unit 20 for a flow electrode, negative ions in the raw water are moved along the flow electrode channel 230 while passing through the negative ion-exchanging films.

However, the first ion-permeable membrane 221 and the second ion-permeable membrane 222 of the negative cartridge unit 20a for a flow electrode may be positive ion-exchanging film. Therefore, when negative power is exerted on the negative cartridge unit 20a for a flow electrode through the negative power line 70, positive ions in the raw water are moved along the flow electrode channel 230 while passing through the positive ion-exchanging films.

At this point, in the embodiment of the present disclosure, using the negative ion-exchanging films for the first ion-permeable membrane 221 and the second ion-permeable membrane 222 of the positive cartridge unit 20 for a flow electrode, and the positive ion-exchanging films for the first ion-permeable membrane 221 and the second ion-permeable membrane 222 of the negative cartridge unit 20a for a flow electrode are merely an embodiment. A material that transmits ions regardless of the ion's polarity can be used as the first ion-permeable membrane 221 and the second ion-permeable membrane 222 of the positive cartridge unit 20 for a flow electrode or the first ion-permeable membrane 221 and the second ion-permeable membrane 222 of the negative cartridge unit 20a for a flow electrode.

Meanwhile, according to the embodiment of the present disclosure, the cartridge unit 20, 20a for a flow electrode may include a pair of electrode fluid inlet tubes 250 and a pair of electrode fluid outlet tubes 260.

The pair of electrode fluid inlet tubes 250 is spaced apart in a lateral direction on upper portions of the plate surfaces of the first case 211 and the second case 212. Furthermore, each electrode fluid inlet tube 250 is formed in a front-rear direction through the first case 211 and the second case 212.

The pair of electrode fluid outlet tubes 260 is spaced apart in a lateral direction on lower portions of the plate surfaces of the first case 211 and the second case 212. Furthermore, each electrode fluid outlet tube 250 is formed in a rearward direction through the first case 211 and the second case 212.

When the cartridge units 20, 20a for a flow electrode are coupled to each other at intervals therebetween in the first direction to form the cartridge array module 10, the electrode fluid inlet tubes 250 of the pair of electrode fluid inlet tubes 250 at corresponding positions of are connected to each other in the first direction, thereby forming a first inner inlet tube 271 and the second inner inlet tube 272.

Likewise, when the plurality of cartridge units 20, 20a for a flow electrode is coupled to each other at intervals therebetween in the first direction to form the cartridge array module 10, the electrode fluid outlet tubes 260 of the pair of electrode fluid outlet tubes 260 at corresponding positions are connected to each other in the first direction, thereby forming a first inner outlet tube 281 and a second inner outlet tube 282.

At this point, one of the pair of electrode fluid inlet tubes 250 of one cartridge unit 20, 20a for a flow electrode includes an electrode fluid inlet hole 251 that allows the corresponding electrode fluid inlet tube 250 and the flow electrode channel 230 to communicate with each other. Likewise, one of the pair of electrode fluid outlet tubes 260 of one cartridge unit 20, 20a for a flow electrode may include an electrode fluid outlet hole 261 that allows the corresponding electrode fluid outlet tube 260 and the flow electrode channel 230 to communicate with each other. As an embodiment, the electrode fluid inlet hole 251 and electrode fluid outlet hole may be formed in the electrode fluid inlet tube 250 and the electrode fluid outlet tube 260 that are located in a diagonal direction.

More specifically, according to the embodiment of the present disclosure, the cartridge array module 10 is provided with the positive cartridge unit 20 for a flow electrode and the negative cartridge unit 20a for a flow electrode, which are alternately arranged in the first direction.

At this point, the electrode fluid inlet hole 251 may be formed in the electrode fluid inlet tube 250, which forms the first inner inlet tube 271, of the pair of electrode fluid inlet tubes 250 of the positive cartridge unit 20 for a flow electrode. Furthermore, the electrode fluid inlet hole 251 may be formed in the electrode fluid inlet tube 250, which forms the second inner inlet tube 272, of the pair of electrode fluid inlet tubes 250 of the negative cartridge unit 20a for a flow electrode.

Furthermore, the electrode fluid outlet hole 261 may be formed in the electrode fluid outlet tube 260, which forms the first inner outlet tube 281, of the pair of electrode fluid outlet tubes 260 of the negative cartridge unit 20a for a flow electrode. Furthermore, the electrode fluid outlet hole 261 may be formed in the electrode fluid outlet tube 260, which forms the second inner outlet tube 282, of the pair of electrode fluid outlet tubes 260 of the positive cartridge unit 20 for a flow electrode.

According to the above configuration, when the electrode fluid flows into the first inner inlet tube 271 and the second inner inlet tube 272 through the external inlet tube 40, the electrode fluid flows through the first inner inlet tube 271 flows into the flow electrode channel 230 of the positive cartridge unit 20 for a flow electrode through the electrode fluid inlet hole 251 formed in the electrode fluid inlet tube 250 while passing through the positive cartridge unit 20 for a flow electrode.

Furthermore, the electrode fluid flowing through the second inner inlet tube 272 flows into the flow electrode channel 230 of the negative cartridge unit 20a for a flow electrode through the electrode fluid inlet hole 251 formed in the electrode fluid inlet tube 250 while passing through the negative cartridge unit 20a for a flow electrode.

At this point, when positive power is exerted on the electrode plate 240 of the positive cartridge unit 20 for a flow electrode, and negative power is exerted on the electrode plate 240 of the negative cartridge unit 20a for a flow electrode, the electrode fluid flowing in the flow electrode channel 230 of the positive cartridge unit 20 for a flow electrode is charged positively, and the electrode fluid flowing in the flow electrode channel 230 of the negative cartridge unit 20a for a flow electrode is charged negatively.

Furthermore, to form passages where the electrode fluids charged positively and negatively flow separately from each other are formed, a separate flow line to supply the electrode fluid to each cartridge unit 20, 20a for a flow electrode is not formed, but a flow line for a flow of the electrode fluid is made from the own structure of the cartridge unit 20, 20a for a flow electrode, which enables structural simplification and reduction of overall size of the product.

Furthermore, the positive cartridge unit 20 for a flow electrode and the negative cartridge unit 20a for a flow electrode of the cartridge array module 10 are formed into a cartridge-type module to maximize the contact area with respect to the raw water, thereby increasing the process performance.

Furthermore, the cartridge unit is formed into a large-area cartridge to support large-area implementation, and reduce the installation space.

Furthermore, the positive cartridge unit 20 for a flow electrode and the negative cartridge unit 20a for a flow electrode are modularized to facilitate management of each unit, thereby providing suitable effects for assembly, installation, and maintenance.

Meanwhile, according to the embodiment of the present disclosure, among the plurality of cartridge units 20, 20a for a flow electrode providing the cartridge array module 10, rear portions of the pair of electrode fluid inlet tubes 250 of the rearmost cartridge unit 20, 20a for a flow electrode are blocked.

Furthermore, among the plurality of cartridge units 20, 20a for a flow electrode, front portions of the pair of electrode fluid outlet tubes 260 of the foremost cartridge unit 20, 20a for a flow electrode are blocked.

Therefore, according to the embodiment of the present disclosure, to produce the cartridge array module 10, the foremost cartridge unit 20, 20a for a flow electrode, the positive cartridge unit 20 for a flow electrode, the negative cartridge unit 20a for a flow electrode, and the rearmost cartridge unit 20, 20a for a flow electrode are modularized.

Meanwhile, according to the embodiment of the present disclosure, the pair of electrode fluid inlet tubes 250 and the pair of electrode fluid outlet tubes 260 of each cartridge unit 20, 20a for a flow electrode protrude forward and rearward from the first case 211 and the second case 212, respectively.

Furthermore, the plurality of cartridge units 20, 20a for a flow electrode is coupled to each other in the first direction to form the cartridge array module 10, the pair of electrode fluid inlet tube 250 and the pair of electrode fluid outlet tubes 260 of the pair adjacent cartridge units 20, 20a for a flow electrode are connected to each other, thereby forming the first inner inlet tube 271, the second inner inlet tube 272, the first inner outlet tube 281, and the second inner outlet tube 282.

As an embodiment, one of the pair of electrode fluid inlet tubes 250 of the rear cartridge unit 20, 20a for a flow electrode and the pair of electrode fluid inlet tubes 250 of the front cartridge unit 20, 20a for a flow electrode may be inserted into the other, thereby forming the first inner inlet tube 271 and the second inner inlet tube 272.

Likewise, one of the pair of electrode fluid outlet tubes of the rear cartridge unit 20, 20a for a flow electrode and the pair of electrode fluid outlet tubes 260 of the front cartridge unit 20, 20a for a flow electrode may be inserted into the other, thereby forming the first inner outlet tube 281 and the second inner outlet tube 282.

In other words, when the cartridge units 20, 20a for a flow electrode are coupled to each other, the electrode fluid inlet tubes 250 may be inserted into each other in a front-rear direction, and the electrode fluid outlet tubes 260 as an example.

As an embodiment, according to the embodiment of the present disclosure, the cartridge unit 20, 20a for a flow electrode may include hook members 2112 and hook grooves 2122.

The hook members 2112 are provided on both side surfaces of the first case 211 of the cartridge unit 20, 20a for a flow electrode in a vertical direction, and have a forward protruding shape. Furthermore, the hook grooves 2122 are formed at positions corresponding to the hook members 2112 on the second case 212.

According to the configuration, when the cartridge array module 10 is made from a plurality of cartridge units 20, 20a for a flow electrode, the hook members 2112 of the rear cartridge unit 20, 20a for a flow electrode are inserted into the hook grooves 2122 of the front cartridge unit 20, 20a for a flow electrode so that the front cartridge unit 20, 20a for a flow electrode and the rear cartridge unit 20, 20a for a flow electrode are coupled to each other at an interval therebetween.

At this point, as described above, the pair of electrode fluid inlet tubes 250 and the pair of electrode fluid outlet tubes 260 of the rear cartridge unit 20, 20a for a flow electrode are coupled to the pair of electrode fluid inlet tubes 250 and the pair of electrode fluid outlet tubes 260 of the front cartridge unit 20, 20a for a flow electrode, and the hook members 2112 are inserted into the hook grooves, so that the rear cartridge unit 20, 20a for a flow electrode and the front cartridge unit 20, 20a for a flow electrode are coupled to each other at an interval therebetween.

Meanwhile, according to the embodiment of the present disclosure, the electrode fluid inlet tube 250 of the cartridge unit 20, 20a for a flow electrode may include a first case inlet tube 2115 and the first case inlet tube 2115.

The first case inlet tube 2115 may be formed by protruding from an inner plate surface of the first case 211 toward the second case 212. Furthermore, the second case inlet tube 2125 may be formed by protruding from the inner plate surface of the second case 212 toward the first case 211.

According to the above configuration, when the first case 211 and the second case 212 are coupled to each other, the first case inlet tube 2115 and the second case inlet tube 2125 are connected to each other to form the electrode fluid inlet tube 250 of the cartridge unit 20, 20a for a flow electrode.

As an embodiment, it is preferable that the diameters of the first case inlet tube 2115 and the second case inlet tube 2125 are designed to allow one of the first case inlet tube 2115 and the second case inlet tube 2125 to be inserted into and coupled to the other. At this point, it is natural that cut portions (not shown) to form the electrode fluid inlet hole 251 are formed on the first case inlet tube 2115 and the second case inlet tube 2125.

According to the embodiment of the present disclosure, the electrode fluid outlet tubes 260 of the cartridge unit 20, 20a for a flow electrode may include a first case outlet tube 2116 and the first case outlet tube 2116.

The first case outlet tube 2116 may be formed by protruding from an inner plate surface of the first case 211 toward the second case 212. Furthermore, the second case outlet tube 2126 may be formed by protruding from an inner plate surface of the second case 212 toward the first case 211.

According to the above configuration, when the first case 211 and the second case 212 are coupled to each other, the first case outlet tube 2116 and the second case outlet tube 2126 are connected to each other to form the electrode fluid outlet tubes 260 of the cartridge unit 20, 20a for a flow electrode.

As an embodiment, it is preferable that the diameters of the first case outlet tube 2116 and the second case outlet tube 2126 are designed to allow one of the first case outlet tube 2116 and the second case outlet tube 2126 to be inserted into and coupled to the other. At this point, it is natural that cut portions (not shown) to form the electrode fluid outlet hole 261 are formed on the first case outlet tube 2116 and the second case outlet tube 2126.

Meanwhile, at least one of the first case 211 and the second case 212 may include a plurality of dispersive guide ribs 2113, 2123. In the embodiment of the present disclosure, as an example, the dispersive guide ribs 2113, 2123 are respectively formed on the first case 211 and the second case 212.

As an example, each dispersive guide rib 2113, 2123 has an inverted V-shape that protrudes from an inner plate surface of each of the first case 211 and the second case 212 toward the electrode plate 240. Accordingly, the electrode fluid flowing inward through the electrode fluid inlet hole 251 is guided by the dispersive guide ribs 2113, 2123, and disperses laterally inside the flow electrode channel 230 and flows downward.

Therefore, the electrode fluid disperses evenly and flows downward, and the super capacitor slurry flowing in the flow electrode channel 230 is evenly spread, which can induce even ion adsorption without a dead zone.

Furthermore, it is possible to prevent the super capacitor slurry from accumulating and clogging at a specific area inside the flow electrode channel 230.

Meanwhile, at least one of the first case 211 and the second case 212 may include discharge guide ribs 2114, 2124. In the embodiment of the present disclosure, as an example, the discharge guide rib 2114, 2124 is respectively formed on the first case 211 and the second case 212.

The discharge guide rib 2114, 2124 may be formed by protruding from a lower area of an inner plate surface of each of the first case 211 and the second case 212 toward the electrode plate 240. Furthermore, the discharge guide rib 2114, 2124 may be inclined downward toward the electrode fluid outlet hole 261.

According to the above configuration, the electrode fluid flowing downward inside the flow electrode channel 230 is guided toward the electrode fluid outlet hole 261 by the discharge guide rib 2114, 2124, enabling a more efficient discharge.

Although the preferred embodiments of the present disclosure have been disclosed for illustrative purposes, those skilled in the art will appreciate that various modifications, additions and substitutions are possible, without departing from the scope and spirit of the present disclosure. The scope of the present disclosure will be defined by the accompanying claims and their equivalents.

### DESCRIPTION OF REFERENCE NUMERAL

1: flow electrode capacitive deionization apparatus
10: cartridge array module 20: cartridge unit for a flow electrode
211: first case 2111: first ion-passing holes
2112: hook members 2113, 2123: dispersive guide ribs
2114,2124: discharge guide rib 2115: first case inlet tube
2116: first case outlet tube 212: second case
2121: second ion-passing holes 2122: hook grooves
2125: second case inlet tube 2126: second case outlet tube
221: first ion-permeable membrane 222: second ion-permeable membrane
230: flow electrode channel 240: electrode plate
250: electrode fluid inlet tube 251: electrode fluid inlet hole
260: electrode fluid outlet tubes 261: electrode fluid outlet hole
271: first inner inlet tube 272: second inner inlet tube
281: first inner outlet tube 282: second inner outlet tube
290: electrode extracting line 40: external inlet tube
50: external outlet tube 60: positive power line
70: negative power line 80: reservoir

### Industrial Application

The present disclosure can be used in the deionization field to remove ions from raw water intended for treatment.

1. A cartridge unit for a flow electrode, the cartridge unit comprising:
a first case with a plate surface on which first ion-passing holes are formed,
a second case with a plate surface on which second ion-passing holes are formed, and coupled to the first case to form a flow electrode channel to allow an electrode fluid to flow therein,
a first ion-permeable membrane attached to the plate surface of the first case and blocking the first ion-passing holes,
a second ion-permeable membrane attached to the plate surface of the second case and blocking the second ion-passing holes, and
an electrode plate located in the flow electrode channel;
wherein when power is exerted to the electrode plate, ions passing through the first ion-permeable membrane and the second ion-permeable membrane are moved along the flow electrode channel.

2. The cartridge unit of claim 1, further comprising:
a pair of electrode fluid inlet tubes spaced apart from each other in a lateral direction on an upper portion of the plate surface of each of the first case and the second case, and formed through each of the first case and the second case in a front-rear direction, and
a pair of electrode fluid outlet tubes spaced apart from each other in a lateral direction on a lower portion of the plate surface of each of the first case and the second case, and formed through the first case and the second case in a front-rear direction;
wherein an electrode fluid inlet hole is formed on one of the pair of electrode fluid inlet tubes to allow the corresponding electrode fluid inlet tube and the flow electrode channel to communicate with each other, so that the electrode fluid flowing through the electrode fluid inlet tube flows toward the flow electrode channel through the electrode fluid inlet hole; and
an electrode fluid outlet hole is formed on one of the pair of electrode fluid outlet tubes to allow the corresponding electrode fluid outlet tube and the flow electrode channel to communicate with each other, so that the electrode fluid in the flow electrode channel is discharged to the electrode fluid outlet tube through the electrode fluid outlet hole.

3. The cartridge unit of claim 2, wherein the electrode fluid inlet tubes comprise first case inlet tubes protruding from the first case toward the second case, and second case inlet tubes protruding from the second case toward the first case, and
the electrode fluid outlet tubes comprise first case outlet tubes protruding from the first case toward the second case, and second case outlet tubes protruding from the second case toward the first case;
wherein when the first case and the second case are coupled to each other, the first case inlet tubes and the second case inlet tubes are connected to each other to form the electrode fluid inlet tubes, and the first case outlet tubes and the second case outlet tubes are connected to each other to form the electrode fluid outlet tubes.

4. The cartridge unit of claim 2, wherein when the first ion-permeable membrane and the second ion-permeable membrane are positive ion-exchanging films, the electrode fluid inlet hole is formed in one of the pair of electrode fluid inlet tubes; and
when the first ion-permeable membrane and the second ion-permeable membrane are negative ion-exchanging films, the electrode fluid inlet hole is formed in the other of the pair of electrode fluid inlet tubes.

5. The cartridge unit of claim 4, wherein the electrode fluid inlet hole and the electrode fluid outlet hole are formed at the electrode fluid inlet tube and the electrode fluid outlet tube that are respectively located in a diagonal direction.

6. The cartridge unit of claim 2, wherein the plurality of first ion-passing holes and the plurality of second ion-passing holes are formed on the plate surface of the first case and the plate surface of the second case.

7. The cartridge unit of claim 2, wherein the first ion-permeable membrane is attached on a front surface of the first case at the outside space of the flow electrode channel; and
the second ion-permeable membrane is attached on a rear surface of the second case at the outside space of the flow electrode channel.

8. The cartridge unit of claim 2, wherein at least one of the first and second cases comprises a plurality of inverted V-shaped dispersive guide ribs that protrude from an inner plate surface toward the electrode plate; and
the electrode fluid flowing inward through the electrode fluid inlet hole is guided by each of the dispersive guide ribs and flows downward while being dispersed in the lateral direction inside the flow electrode channel.

9. The cartridge unit of claim 2, wherein at least one of the first and second cases comprises a discharge guide rib that protrudes from a lower area of an inner plate surface toward the electrode plate, and is formed to be inclined downward toward the electrode fluid outlet hole; and
the electrode fluid flowing downward in the flow electrode channel is guided by the discharge guide rib and enabled to flow in a direction toward the electrode fluid outlet hole.

10. A flow electrode capacitive deionization apparatus comprising:
a cartridge array module in which a plurality of cartridge units for a flow electrode according to claim 1 is arranged to face each other in a first direction while being spaced apart from each other,
an external inlet tube supplying the electrode fluid to the cartridge array module,
an external outlet tube discharging the electrode fluid passing through the cartridge array module, and
a positive power line and a negative power line alternately connected to each electrode plate of the plurality of cartridge units for a flow electrode, so that the plurality of cartridge units for a flow electrode is provided with a positive cartridge unit for a flow electrode and a negative cartridge unit for a flow electrode alternately arranged in the first direction.

11. The flow electrode capacitive deionization apparatus of claim 10, wherein each of the cartridge units for a flow electrode further comprises: a pair of electrode fluid inlet tubes spaced apart from each other in a lateral direction on an upper portion of the plate surface of each of the first case and the second case, and formed through each of the first case and the second case in a front-rear direction, and a pair of electrode fluid outlet tubes spaced apart from each other in a lateral direction on a lower portion of the plate surface of each of the first case and the second case, and formed through the first case and the second case in a front-rear direction;
wherein the electrode fluid inlet tubes at corresponding positions of the pair of electrode fluid inlet tubes of the cartridge units for a flow electrode are connected to each other in the first direction to form a first inner inlet tube and a second inner inlet tube;
the electrode fluid outlet tubes at corresponding positions of the pair of electrode fluid outlet tubes of the cartridge units for a flow electrode are connected to each other in the first direction to form a first inner outlet tube and a second inner outlet tube;
an electrode fluid inlet hole is formed in the electrode fluid inlet tube, which provides the first inner inlet tube, of the pair of electrode fluid inlet tubes of the positive cartridge unit for a flow electrode, and an electrode fluid inlet hole is formed in the electrode fluid inlet tube, which provides the second inner inlet tube, of the pair of electrode fluid inlet tubes of the negative cartridge unit for a flow electrode; and
an electrode fluid outlet hole is formed in the electrode fluid outlet tube, which provides the first inner outlet tube, of the pair of electrode fluid outlet tubes of the negative cartridge unit for a flow electrode, and an electrode fluid outlet hole is formed in the electrode fluid outlet tube, which provides the second inner outlet tube, of the pair of electrode fluid outlet tubes of the positive cartridge unit for a flow electrode.

12. The flow electrode capacitive deionization apparatus of claim 11, wherein the first ion-permeable membrane and the second ion-permeable membrane of the positive cartridge unit for a flow electrode are negative ion-exchanging films, and
the first ion-permeable membrane and the second ion-permeable membrane of the negative cartridge unit for a flow electrode are positive ion-exchanging films.

13. The flow electrode capacitive deionization apparatus of claim 12, wherein the external inlet tube is connected to the pair of electrode fluid inlet tubes of the foremost cartridge unit for a flow electrode of the plurality of cartridge units for a flow electrode, and supplies the electrode fluid to the first inner inlet tube and the second inner inlet tube; and
the external outlet tube is connected to the pair of electrode fluid outlet tubes of the rearmost cartridge unit for a flow electrode of the plurality of cartridge units for a flow electrode, and discharges the electrode fluid that flows through the first inner outlet tube and the second inner outlet tube.

14. The flow electrode capacitive deionization apparatus of claim 13, wherein the rear portions of the pair of electrode fluid inlet tubes of the rearmost cartridge unit for a flow electrode of the plurality of cartridge units for a flow electrode are blocked; and
the front portions of the pair of electrode fluid outlet tubes of the foremost cartridge unit for a flow electrode of the plurality of cartridge units for a flow electrode are blocked.

15. The flow electrode capacitive deionization apparatus of claim 14, wherein the pair of electrode fluid inlet tubes and the pair of electrode fluid outlet tubes of each cartridge unit for a flow electrode protrude respectively forward and rearward from the first case and the second case; and
the pair of electrode fluid inlet tubes and the pair of electrode fluid outlet tubes of the rear cartridge unit for a flow electrode and the pair of electrode fluid inlet tubes and the pair of electrode fluid outlet tubes of the front cartridge unit for a flow electrode are inserted such that one is inserted into the other, thereby forming the first inner inlet tube, the second inner inlet tube, the first inner outlet tube, and the second inner outlet tube.

16. The flow electrode capacitive deionization apparatus of claim 15, wherein a side surface of the first case of each cartridge unit for a flow electrode comprises a pair of hook members that protrude in a vertical direction forward, and the second case comprises hook grooves formed at positions corresponding to the hook members, and
when the pair of electrode fluid inlet tubes and the pair of electrode fluid outlet tubes of the rear cartridge unit for a flow electrode are coupled to the pair of electrode fluid inlet tubes and the pair of electrode fluid outlet tubes of the front cartridge unit for a flow electrode, the hook members are inserted into the hook grooves, so that the rear cartridge unit for a flow electrode and the front cartridge unit for a flow electrode are coupled to each other while being spaced apart from each other.
